(19) United States
(12) Patent Application Publication
(10) Pub. No.: US 2025/0385942 A1
(43) Pub. Date: Dec. 18, 2025

(54) Handling of Conditional Access Policies

(71) Applicant: Pro-Vision Software Solutions Ltd., Caesarea industrial park (IL)

(72) Inventors: Yaaqov TARAGANO, Caesarea (IL); Nadav SOLOMON, Kfar Vradim (IL)

(21) Appl. No.: 19/240,410

(22) Filed: Jun. 17, 2025

Related U.S. Application Data
(60) Provisional application No. 63/660,706, filed on Jun. 17, 2024.

(51) Int. Cl. H04L 9/40

(52) U.S. Cl. CPC H04L 63/20; H04L 63/10

(57) ABSTRACT

A conditional access policy management system which enables organizations' administrators to manage conditional access policies controlling user access to respective organizational assets, e.g., apps which respective organizations may store on a cloud, the system comprising a user interface enabling an administrator to select a policy, to define a selected policy; and/or a processor which may be configured to display a timeline along which a sequence of plural time-points may be arranged wherein changes were made in said selected policy at each of the plural time-points.

### REFERENCE TO CO-PENDING APPLICATIONS

None.

### FIELD OF THIS DISCLOSURE

The present invention relates generally to access control, and more particularly to controlling typically remote access to an organization's digital resources.

### BACKGROUND FOR THIS DISCLOSURE

Conventionally, administrators design Conditional Access policies (e.g. determine which access controls to apply to which of the organization's resources) to facilitate the goals of (a) enabling users to be productive simultaneously, and (b) protecting the organization's assets from malevolent actors. An organization may have plural tenants, and even a single tenant may have dozens or even hundreds of policies.

“Protected actions” are defined in Microsoft Entra ID, e.g., as described online at the following link: learn.microsoft.com/en-us/entra/identity/role-based-access-control/protected-actions-overview. Microsoft teaches: “Don't use protected actions to block access based on identity or group membership. Protected actions are used to apply an access requirement to perform a protected action. They aren't intended to block use of a permission just based on user identity or group membership. Who has access to specific permissions is an authorization decision and should be controlled by role assignment”.

Microsoft Entra ID has a multitenant organization feature which enables creation of a tenant group within an organization. This is useful for corporate organizations, after merger and acquisitions, for example.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

Materiality of such publications and patent documents to patentability is not conceded.

### SUMMARY OF CERTAIN EMBODIMENTS

Certain embodiments seek to provide efficient conditional access policy management, using “management” in the general sense, whereas below, a “managed” policy is used in a particular sense to refer to a policy which can be changed, but only pending admin approval.

Certain embodiments seek to provide a cloud security system to backup and restore conditional access policies.

Certain embodiments seek to provide a conditional access policy management system configured to accept a user input, defining, for a certain policy which the user has selected, and responsively, to present, to the user, a timeline and associated cursor which slides along the timeline and, responsive to the user's selection of a time-point (e.g. responsive to the user's moving the cursor along the timeline) to display to the user the state or configuration of the selected policy at the selected time-point, e.g., which values were assigned to various policy parameters at that time-point.

Certain embodiments seek to provide a conditional access policy management system which manages and/or protects plural conditional access policies, which, in turn, are defined by each of multiple organizations and/or tenants to protect each organization's and/or tenant's assets by governing or controlling access to the assets, wherein, typically, the number of policies defined by an organization to govern access to a given asset may be zero, one, a few, or many policies. Conversely, a given policy defined by an organization may govern or control access to zero, one, a few, or many assets. The system displays data regarding each policy's state at given dates, and the data includes entities such as, say, users, groups of users, and policies, each of which is associated with an identifier e.g. GUID, typically uniquely over all entities defined by all policies by all organizations. Typically, when the system presents, to users in a given organization A, data regarding a given state of one of organization A's policies at a given date, the system replaces GUIDs in the data with user-names used in organization A, whereas when the system presents, to users in a given organization B, data regarding a given state of one of organization B's policies at a given date, the system replaces GUIDs in the data with user-names used in organization B.

Certain embodiments seek to provide a conditional access policy management system configured to repeatedly (e.g. every 5 minutes) export all tenants' conditional access policies using a suitable tool such as Microsoft Graph.

Certain embodiments parse or analyze a Microsoft log of changes which records changes between consecutive points in time, and generate an output, e.g., cumulative output, e.g., tree, which presents changes between any selected pair of non-consecutive points in time. In the illustrated embodiment, the tree shows changes in Microsoft Entra ID parameter, such as “conditions”, “includeUsers”, etc., however this is not intended to be limiting.

Certain embodiments seek to provide a multi-tenant conditional access policy management solution which allows administrators to easily identify differences and/or to alert admins of changes in certain conditional access policies and/or protect against changes in certain conditional access policies and/or provide a timeline of changes and/or create a required approval workflow for certain changes in certain conditional access policies.

Certain embodiments seek to provide a conditional access policy management method configured to efficiently, securely, and reliably, backup and restore conditional access policies including all or any subset of:
protecting policies from unauthorized changes
implementing an approval workflow for policy changes
providing a graphical interface to visualize policy changes, and
enabling point-in-time restoration of policies.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

Thus the present invention typically includes at least the following embodiments:

Embodiment 1. A conditional access policy management system which enables organizations' administrators to manage conditional access policies controlling user access to respective organizational assets, e.g., apps which respective organizations may store on a cloud, the system comprising a user interface typically enabling an administrator to select a policy, e.g. to define a selected policy; and/or a processor which may be configured to display a timeline along which a sequence of plural time-points are arranged wherein changes were made in the selected policy at each of the plural time-points.

For example: a policy P (which controls access by an organization's users to certain of the organization's assets e.g. to SharePoint, or some other app used by the organization), was changed at 3 timepoints:
at timepoint t1, policy P was enabled and its conditions were applied to a first user group.

At timepoint t2, policy P was disabled and its conditions were also applied to a second user group.

At timepoint t3, policy P was enabled again and its conditions were deemed to no longer apply to the first user group.

Thus, currently, policy P is enabled, and its conditions apply to the second user group but not to the first.

The data indicative of cumulative changes made at t1,t2 and t3 respectively May include the above information, respectively.

Typically, the timeline includes all time-points at which the selected policy was changed and does not include any time-points at which the selected policy was not changed.

Embodiment 2. A system according to any of the preceding embodiments wherein the user interface enables an administrator to select an organizational asset A, and, responsively, the processor is configured to search, among time-points at which changes were made in policies, for first time-points at which changes were made in policies which control user access to organizational asset A, and to provide the administrator with an indication of only the first time-points and not of second time-points at which changes were made only in policies which only control user access to organizational assets other than asset A.

Typically the search is a GUID search performed on a data repository storing policy changes which includes, for each record corresponding to a given policy, a field storing GUID/s of asset/s to which the policy applies. So for example, responsive to a request made by an administrator for organization B, the processor may search for all time-points at which changes were made in organization B's policies which control access of organization B's users to, say, SharePoint, which may be one of organization B's assets.

Embodiment 3. A system according to any of the preceding embodiments wherein the indication of the first time-points which is served to the administrator, includes data, e.g. a tree, indicative of changes made in the policies which control user access to organizational asset A, at each of the first time-points.

Embodiment 4. A system according to any of the preceding embodiments wherein a change C is deemed to have been made at a time-point T if an administrator keyed in change C then pressed “save” at time-point T.

According to one embodiment, a single platform is used both to define conditional access policies and to manage and monitor the process of defining these policies. According to an alternative embodiment, a first platform (e.g. Microsoft) is used to define conditional access policies and a second (typically external) platform is used to manage and monitor the process of defining these policies; in this latter case, the change C is typically made using the first platform and change C is typically deemed, by the second platform, to have been made at a time-point T if an administrator keyed in change C then pressed “enter” at time-point T.

Embodiment 5. A system according to any of the preceding embodiments and also comprising a data repository comprising a plurality of records, each corresponding to a policy, wherein each record corresponding to policy P comprises a field indicating organizational assets to which policy P applies.

Embodiment 6. A system according to any of the preceding embodiments wherein the data indicative of changes comprises, for each time-point T from among the first time-points, a cumulative indication of all changes made at, or by, time-point T to at least one asset.

Embodiment 7. A system according to any of the preceding embodiments wherein the user interface enables administrators to initiate change of at least one policy.

Embodiment 8. A system according to any of the preceding embodiments and wherein the user interface enables an administrator super-user to limit changes which can be initiated by an administrator.

For example, the super-user may define that certain “protected” policies cannot be changed at all, by any administrator other than himself. And/Or, the super-user may define that certain policies can be changed by an administrator, however such changes go into effect only contingent upon approval by the super-use. Or, the super-user may define that any change which applies to many users e.g. to a group of all users (as opposed to changes applying only to small groups//subsets of users or to individual users) requires approval or cannot be changed/cannot go into effect at all.

Embodiment 9. A system according to any of the preceding embodiments wherein the user interface limits changes by enabling an administrator super-user to prevent at least one change from being made to at least one policy, by at least one administrator.

Embodiment 10. A system according to any of the preceding embodiments wherein the user interface limits changes by enabling an administrator super-user to define that at least one change to at least one policy requires approval before going into effect.

Embodiment 11. A system according to any of the preceding embodiments wherein the conditional access policy management system enables plural organizations' administrators to respectively administer conditional access policies controlling access of each organization's users to each organization's assets, and wherein unique identifiers, e.g., GUIDs, are used to identify entities uniquely over the plural organizations, and wherein each organization assigns display names, typically in clear text or natural language, to the entities, and wherein the system includes a dictionary which stores at least one association between at least one of the unique identifiers and at least one of the display names, and wherein the processor is configured to convert at least one of the unique identifiers to display name/s, for display to an administrator via the user interface, and/or to convert the display names which may have been received from an administrator via the user interface, to unique identifiers, for internal purposes, based on the association.

Individual entities may each comprise an individual user. And/or, certain/all individual entities may each comprise an entire group of users. For example, one entity, which may be uniquely identified by a specific GUID, may for example include the group of “all users”. Another entity, which may be uniquely identified by another GUID, may include all users in an organization which belong to a particular category (which may be organization-specific) such as (say, in an organization which is a bank) the category of all tellers, the category of all analysts, the category of all managers, etc. Any entity may even comprise a group of entities (e.g. a group of groups of users). For example, one entity, which may be uniquely identified by a specific GUID, may be a group including 3 members: the group of junior managers (which is itself an entity which may be uniquely identified by its own specific GUID), the group of mid-level managers (ditto) and the group of senior managers (ditto).

Embodiment 12. A system according to any of the preceding embodiments wherein the entities identified by unique identifiers includes at least one user and/or at least one group of users.

Embodiment 13. A system according to any of the preceding embodiments wherein the entities identified by unique identifiers include an “all users” group to which all an organization's users belong, thereby to display data regarding aspects of conditional access policies which apply to the group of all users in association with an intuitive “all users” display name, enabling even an administrator who has not committed the unique identifier of the “all users” group to memory, to easily identify changes which apply to all users, hence are particularly important.

Embodiment 14. A system according to any of the preceding embodiments wherein the entities identified by unique identifiers include at least one user and/or at least one app and/or at least one policy and/or at least one tenant and/or at least one organization.

Embodiment 15. A system according to any of the preceding embodiments wherein at least one organization assigns display names via Microsoft Entra ID.

Embodiment 16. A system according to any of the preceding embodiments and wherein the processor is configured to serve to the administrator, e.g. upon demand, data indicative of cumulative changes made in the policy at an administrator-selected time-point from among the plural time-points, vis a vis the policy's current configuration.

Typically this is the case not only for a pair of time-points which are consecutive (e.g. the policy was not changed in the time-window between the pair of time-points) but also for any non-consecutive time-points e.g. if the policy was changed multiple times at multiple time-points lying in between the selected and current time-points e.g. because the system has backed up all changes which occurred over time and each such change, for each policy defined for each tenant or organization, is typically time-stamped.

Embodiment 17. A system according to any of the preceding embodiments wherein an administrator can query the system to determine which policies control access to a given organizational asset A, and, responsively, the system identifies and presents to the administrator, at least some, e.g., all policies which control access to the organizational asset A.

Typically, responsive to the administrator querying the system, the portal of the system queries the database or Entra ID.

Embodiment 18. A system according to any of the preceding embodiments which supports a “Lock Mode” for tenants which, when enabled for a given tenant, prevents changes to any of the given tenant's policies, e.g,. by deleting new policies created for the given tenant while the given tenant is in Lock Mode state.

According to certain embodiments, any new policy deleted while in “lock mode” is not re-instated even once “lock mode” is removed. instead, the admin will need to create this policy again. Alternatively, if new policies are created then automatically deleted for locked tenant t, these new policies are reinstated when the tenant is unlocked. Their initial state may automatically be defined e.g. as “protected” or “managed” or neither.

According to certain embodiments, “lock mode” sets all policies other than new policies (which are deleted) into “protected” status. When lock mode is removed, statuses of policies other than new policies may or may not be restored to their former status which may not have been “protected”.

Embodiment 19. A system according to any of the preceding embodiments wherein, when a given tenant in Lock Mode is unlocked by a user so authorized, each of the given tenant's policies open back to its respective last state, e.g., Protected/Managed/Neither.

Embodiment 20: A conditional access policy management method comprising: enabling organizations' administrators to manage conditional access policies controlling user access to respective organizational assets, e.g., apps, which respective organizations may store on a cloud, by providing a user interface typically enabling an administrator to select a policy, e.g. to define a selected policy; and/or using a processor, generating and/or displaying a timeline along which a sequence of plural time-points are arranged wherein changes were made in the selected policy at each of the plural time-points.

Embodiment 21. A computer program product, comprising a non-transitory tangible computer readable medium having computer readable program code embodied therein, the computer readable program code adapted to be executed to implement a conditional access policy management method comprising:
enabling organizations' administrators to manage conditional access policies controlling user access to respective organizational assets, e.g., apps, which respective organizations may store on a cloud, by:
   providing a user interface enabling an administrator to select a policy, thereby to define a selected policy; and
   using a processor, generating and displaying a timeline along which a sequence of plural time-points are arranged wherein changes were made in the selected policy at each of the plural time-points.

Also provided, excluding signals, is a computer program comprising computer program code means for performing any of the methods shown and described herein when the program is run on at least one computer, and a computer program product, comprising a typically non-transitory computer-usable or-readable medium e.g. non-transitory computer-usable or-readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or a general-purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMS, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g. BLE) or wired (e.g. USB)), or a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting;

thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features, and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general-purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner, and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices, or may be provided to external factors, e.g., via a suitable data network. The term “computer” should be broadly construed to cover any kind of electronic device with data processing capabilities, including, by way of non-limiting example, personal computers, servers, embedded cores, computing systems, communication devices, processors (e.g., digital signal processors (DSPs), microcontrollers, field programmable gate arrays (FPGAs), application specific integrated circuits (ASICs), etc.), and other electronic computing devices. Any reference to a computer, controller, or processor is intended to include one or more hardware devices, e.g., chips, which may be co-located, or remote from one another. Any controller or processor may, for example, comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface, or other system illustrated or described herein. Any suitable computerized data storage, e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include a user interface which may, for example, include all or any subset of an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof, and back-end logic interacting therewith. Thus, the term user interface, or “UI”, as used herein, includes also the underlying logic which controls the data presented to the user, e.g., by the system display, and receives and processes data entered by a user, e.g., using her or his workstation/device.

### BRIEF DESCRIPTION OF THE DRAWINGS

Certain embodiments of the present invention are illustrated in the following drawings; in the block diagrams, arrows between modules may be implemented as APIs and any suitable technology may be used for interconnecting functional components or modules illustrated herein in a suitable sequence or order, e.g., via a suitable API/Interface. For example, state-of-the-art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

FIG. 1 is an example System Architecture Diagram.

FIG. 2 is an example simplified screen display which may be generated by a system of the present invention. The screen display shows an example timeline for an example policy.

FIG. 3 is an example simplified screen display which may be generated by a system of the present invention which shows policies presented to an administrator.

Methods and systems included in the scope of the present invention may include some (e.g. any suitable subset) or all of the functional blocks shown in the specifically illustrated implementations by way of example, in any suitable order e.g. as shown.

Computational, functional, or logical components described and illustrated herein, can be implemented in various forms, for example, as hardware circuits, such as but not limited to custom VLSI circuits or gate arrays or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences, such as but not limited to objects, procedures, functions, routines, and programs and may originate from several computer files which typically operate synergistically.

Each functionality or method herein may be implemented in software (e.g. for execution on suitable processing hardware such as a microprocessor or a digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively, or in addition, modules or functionality described herein may be performed by a general-purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC or DSP or any suitable combination thereof.

Any hardware component mentioned herein may, in fact, include either one or more hardware devices, e.g., chips, which may be co-located, or remote from one another.

Any method described herein is intended to include within the scope of the embodiments of the present invention also any software or computer program performing all or any subset of the method's operations, including a mobile application, platform, or operating system, e.g., as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line; which is of any type or level or amount or category of volatility, differentiation, mutability, accessibility, addressability, capacity, performance and energy use; and which is based on any suitable technologies, such as semiconductor, magnetic, optical, paper and others.

### DETAILED DESCRIPTION OF CERTAIN EMBODIMENTS

According to an embodiment of the invention, two separate platforms or bodies of code are provided, including a first platform or body of code which enables policies to be changed, and a second platform or body of code, aka GK, which provides management functionality, absent from the first platform, for policy changes which are made via the first, MS platform, such as functionality for defining key policy states regarding which changes are restricted or prohibited and/or defining certain changes (e.g. changes which apply to “all users” of an organization) which are restricted or prohibited and/or such as functionality for conveniently handling crises including restoring policies to previous states. Typically, each GK user organization runs GK in its own software environment and can connect to its own managed tenants (and not to any other user organization's tenants).

According to this embodiment, the second body of code may for example protect certain policies (e.g. effectively prevent them from being changed until global admin approves), say, by rapidly, e.g., within a few seconds or less, or within a few minutes, changing a new setting for a policy parameter back to the old setting, and contacting global admin to seek approval for the change; upon receipt of such approval, the old setting is changed back to the new setting. It is appreciated that if the same body of code both enables policies to be changed and provides management functionality for protecting policies from being inappropriately changed, then the body of code may change an existing setting of a conditional policy characteristic/parameter to a new setting of the conditional policy characteristic/parameter, only if and when the global admin has responded to a request by the body of code that the requested new setting is approved.

Certain embodiments provide a system for managing and/or monitoring and/or manipulating and/or restoring conditional access policies such as Microsoft Entra ID conditional access policies e.g. by using Microsoft Graph and an EXE file and a web portal to collect and/or compare and/or display policy information and/or enable and/or facilitate policy restoration.

Any embodiment or feature or functionality herein may be combined with the functionality of cumulating and/or generating and/or providing to a user all changes in all parameters or characteristics of a current configuration of a given conditional access policy (or other object), at a given time-point relative to a current configuration of the same conditional access policy (or other object). Typically, the functionality is capable of performing this for any point in time once the system is deployed.

The system herein may access a system for defining conditional access policies (or other objects) such as Entra ID's Conditional Access security feature. This may occur at scheduled times, e.g. every m minutes. Any suitable API may be used to pull updates (e.g. the Microsoft Graph API). Alternatively, or in addition, the system herein may pull Entra ID logs. Again, any suitable API may be used for this purpose (again such as but not limited to the Microsoft Graph API).

Entra ID for example has a Conditional Access security feature for certain (“premium”) tenants which enables tenants' administrators (e.g.) to define and implement Conditional Access policies that control access to resources or assets, e.g., applications based on certain conditions or criteria, including but not limited to user identity, device compliance, location. Each of the Conditional Access policies typically comprises if-then statement/s, e.g., if a tenant's user wants to access a resource or asset (e.g. an application or service of a tenant organization like Microsoft 365 or SharePoint), then that user must, say, complete an action (e.g. multifactor authentication) to gain access. This enables administrators to empower their organization's users to be productive in desired locations and at desired times, and, simultaneously, to protect the organization's assets.

Typically, the system runs an EXE file repeatedly, e.g., periodically, e.g., every 5 minutes, to collect information about the current state of Microsoft Entra ID conditional access policies through Microsoft Graph (e.g.: enabled/disabled/record? includeUsers includes which users? etc.). Typically, the 5 minute (say) interval is counted from the time the EXE is initiated.

The term “disabled” may be used herein to describe a policy which refers to a policy which is not active or off, e.g., as defined in Microsoft Entra ID.

Typically, each time an admin wants to compare policy on a given first point in time e.g. 1 April with the same policy at a current (later) point in time e.g. 27 April, the system generates and presents a cumulative display which directly compares 27.4 to 1.4, even if the first and current points are non-consecutive, e.g., even if the policy changed at several point/s in time intermediate the first and current points in time; typically, if a certain change was made on 5.4, then reversed on 6.4, this change may not be part of the cumulative display. In contrast, conventional systems may show comparisons only between consecutive points in time.

It Is appreciated that Microsoft “Entra'ID (formerly known as Microsoft Azure Active Directory or Azure AD) is but one example of a cloud-based identity and access management (IAM) solution having a directory and identity management service that operates in the cloud, offering authentication and authorization services to organizations and other users with applications which are cloud-based and/or on-premises.

Alternatively, any other solution may be used. Such solutions may offer any suitable authentication methods, such as but not limited to all or any subset of password-based, multi-factor, smart card, and certificate-based authentication. Such solutions may offer security features, such as Conditional Access policies and/or risk-based authentication and/or identity protection.

It is appreciated that “Microsoft Graph” is but one example of an API developer platform that connects plural services and/or plural devices.

Thus, references herein to Microsoft products, such as Microsoft Entra ID and Microsoft Graph, are merely by way of example, and are not intended to be limiting.

The system may compare the collected information with information stored in a database (aka policy state database), e.g., all or any subset of the information described in detail below.

Typically, as soon as code implementing functionality described herein is installed, the code queries the tenant for its policy states, and retrieves or stores all relevant policy state information resulting from the policy state query process, into the database. The system (e.g. code implementing functionality described herein) may update the database with any changes, thereby to update the stored information to match the information as collected.

The system may display to its users, a timeline of changes in the portal, showing differences between the current state of (e.g. most recently collected information regarding) policy/ies, and previous state/s of the policies. In conventional systems which lack the timeline of changes, administrators must go into detailed logging of changes in their environment to try to understand what was changed in their policies.

Thus, typically, the system is configured to accept a user input defining, for a certain policy which the user has selected, to present, to the user, a timeline and associated cursor which slides along the timeline and, responsive to the user's selection of a time-point (e.g. responsive to the user's moving the cursor along the timeline), to display to the user the state of the selected policy at the selected time-point.

The system typically allows at least one user, e.g., one or more designated user/s in each organization, to restore at least one given policy (e.g. as selected by the user) to that policy's state as it was at a selected time-point along in the timeline. Microsoft Graph may, for example, be used to apply changes to achieve this restoration. Typically, if changes 1, 2, . . . . C were made from the selected time-point till the present, restoration to the selected time-point may be achieved e.g. by applying changes C, C-1, C-2, . . . 2, 1 to the given policy's current state. Alternatively, GK changes the policy straight to the time-point settings (by applying the combined or cumulative effect of all changes made to the policy, rather than by going through multiple restorations). Thus, for example, if policy parameter x increased, say, from 3 to 5, then back to 3, then up to 6, the system may change 6 straight back to 3.

According to certain embodiments the system backs up all changes in conditional access policies, and the admin can then choose any date/time that given policy/ies are to be restored to; at this point the system restores all policy settings to the settings configured on 13 July @3 PM (for example).

According to an alternative embodiment, the system undoes all changes made subsequent to this point in time, last to first. For example, if on 13 July @3 pm admin chooses to restore a given policy to its state on 17 June @4 pm, and if a sequence of 12 changes were made in the time-window between 13 July @3 pm and 17 June @4 pm, e.g. first change1, then change2, . . . and finally change12, then responsive to the restore request the system undoes change 12, then undoes change 11, and so forth, finally undoing change1 thereby to restore the given policy to its state on 17 June @ 4 pm.

The system may also collect (and typically display) the displayNames of GUIDs configured in the policies, such as applications, servicePrincipals, locations, users, groups, etc.

The term globally unique identifier (GUID) as used herein is intended to include any identifier which may be used in software applications and which is unique over all entities to which such identifiers are assigned (“Globally”). The term GUID includes but is not limited to Microsoft's implementation of the Universally Unique Identifier (UUID) standard.

An example architecture may include all or any subset of:
a. Management portal: A web-based interface for administrators, and approvers to manage and visualize policy changes and audit logs. The management portal may include all or any subset of the following components:
a1. UI Components: Dashboards, policy visualization, approval workflow interface.
a2. Client-Side Logic: handling user interactions, form validations and API calls.
a3. API Layer: RESTful APIs for frontend communication and interaction with the SQL database.
a4. Authentication and Authorization: integration with Entra ID for user authentication.
b. Executable: A command-line application responsible for performing backup, restore operations and collection of display names and audit logs from Entra ID using Microsoft Graph. The executable may include all or any subset of the following components:
b1. Backup Module: Handles the extraction of Entra ID CA policies using Microsoft Graph and stores them in the database.
b2. Restore Module: Retrieves CA policies from the database and restores them to Entra ID.
b3. Logging and Error Handling: Comprehensive logging for auditing and error handling to ensure reliable operations.
c. Database: A Microsoft SQL Server database for storing backup data, audit logs, and workflow information. The database may include all or any subset of the following tables:
c1. Tbl_admins: contains administrators information and permissions
c2. Tbl_tenants: contains Entra ID tenant information
c3. Tbl_adminId2tenantId: linking table between tbl_admins and tbl_tenants.
c4. Tbl_policies: contains conditional access policies settings.
c5. Tbl_audit: portal operations audit table.
c6. Tbl_configuration: basic portal configuration.
c7. Tbl_logs: contains executable operations log.
c8. Tbl_runs: contains executable run information.
c9. Tbl_signinsAuditLogs: contains Entra ID sign-ins audit logs.
c10. Tbl_signInsAuditLogsExcludedApplications: contains excluded applications for the web portal dashboard.
c11. Tbl_directoryAuditLogs: contains Entra ID directory audit log.
c12. Tbl_restoreJobs: contains information of restore jobs.
c13. Display names tables: contain GUID to display name mapping, this may include all or any subset of the following tables:
Tbl_applications
Tbl_authenticationContext
Tbl_directoryRoles
Tbl_externalTenants
Tbl_groups
Tbl_namedLocations
Tbl_users

It is appreciated that the platform or body of code, aka GK, which provides management functionality for conditional access policy changes, may provide any suitable Conditional Access Backup and Restore Application functionality. As described, the GK application may run an executable repeatedly, e.g., every 5 minutes, and/or may provide a web application to view and manage backups of conditional access policies. The application is configured to protect conditional access policies from unauthorized or accidental changes and/or and to restore conditional access policies to their desired state, if and as needed, e.g., upon request. The application may collect audit logs and/or policy changes, and may send notifications, e.g., by emails, to admins. All operations on Entra ID may be done using Microsoft Graph, but this is not intended to be limiting. All or any subset of the following tasks may be performed every 5 minutes (say) by the executable:
the executable collects all the tenants configurations from the database.
the executable checks if there are restore jobs in the database. If there are, the executable restores or creates the conditional access policy configuration from the database into Entra ID conditional access of the specific tenant.
For each tenant, the executable checks whether a protected policy was changed. A protected policy is a policy that has a protection flag set using the web application. If a protected policy was changed, the executable restores that policy to its protected state from the database (e.g. the configuration settings of the conditional access when set to protected).
If a protected policy is changed to unprotected, the executable renames that policy and typically removes a “***Protected by CAGK***” prefix from its name. If a policy was set as protected, the executable adds this prefix to that policy's name.
the executable gets audit logs from sign-ins audit logs and directory audit logs, and writes the logs to the database.
the executable gets changes in conditional access policies, and writes them to the database.
For every change in Conditional Access, the executable informs e.g. dispatches an email to the admins configured to receive mail notifications in the database.
the executable collects display names of the objects configured in the policies, since they are configured as object IDs.
the executable checks whether a managed policy was changed. A managed conditional access policy is a type of policy that requires an approval from a designated group of global admins before any change in the policy settings can take effect. A prefix of “***Managed by CAGK***” may be added to any policy set as managed. The system may first revert the change so that the policy may remain unchanged, may add the “Pending Changes” prefix to the policy name in Entra ID, so that other policy admins may be aware that there is a change in the policy that is pending approval, and no other changes can be requested during this time. The system may then send an email to the group of global admins with the details of the proposed change to a given policy and a link to approve or reject the proposed change. The change may be applied to the policy if, say, any member of this group approves the proposed change; alternatively, any other condition for change application may be defined e.g. all group members must approve, etc.

It is appreciated that, generally, any stipulation that a certain user or type or group of users is entitled to perform a certain operation, is not included to be limited; thus for example, any operation which this disclosure says an admin may perform, may alternatively be limited to global admin only, or vice versa.

The web application typically allows the admins to view and manage the backups of the conditional access policies. The web application may have all or any subset of the following features:
The web application displays the list of tenants and their policies, along with their backup status, protection status, and last modified date.
The web application allows, say, global admins to set or unset the protection flag for each policy.
The web application allows the admins to set or unset the managed flag for each policy.
The web application allows designated admins e.g. global admins, to approve or reject a pending change in a managed policy.
The web application allows admins to create restore jobs for each policy, which may be executed by the executable in the next run.
The web application allows the admins to view the audit logs and policy changes for each tenant and policy.
The web application allows the admins to configure the mail notifications settings, such as the recipients, the frequency, and the content of the emails.
The web application shows the “timeline of changes” in conditional access policies and the details of each change that occurred, typically since the system described herein was deployed. The conditional access timeline helps admins to track the history of policy modifications and identify any potential issues or conflicts that may affect the security and compliance of the tenants. The web application typically displays a graphical representation of the policy changes over time. By clicking on a specific change in the timeline, admins can see modified values of the policy. Thus, admins can easily understand what has changed and take appropriate actions if needed.

The web application may have advanced operations, a section or set of functionalities which lets admins perform certain bulk actions on policies, acting upon a set of policies e.g. all policies rather than acting upon individual policies. For example, use of advanced operations may allow admins to disable all policies (e.g. all conditional access policies currently in effect in a given organization) in a single click, or restore all policies to a selected date by a single click. These operations are useful e.g. when there is a need to suspend or revert backup and restore processes for all tenants and policies.

An example system configured to backup and restore Microsoft Entra ID conditional access (CA) policies is now described in detail, including example design of the management portal, executable, and Microsoft SQL database, and suggested security, workflow, and version control aspects of the system.

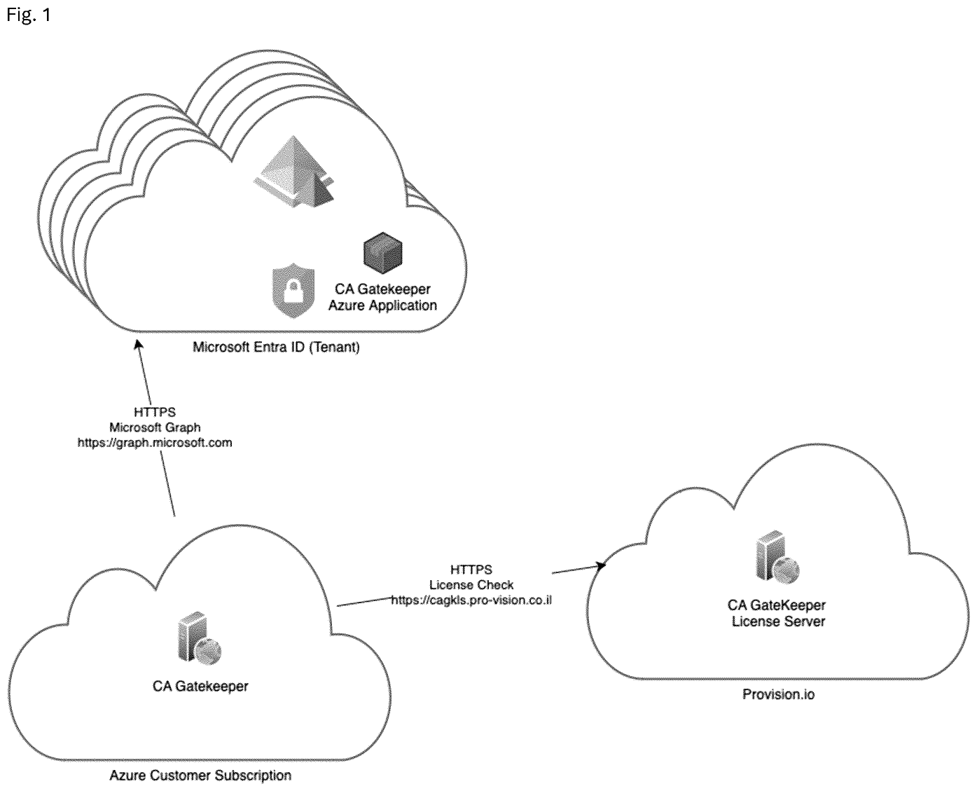

An example System Architecture Diagram is illustrated in FIG. 1.

The system typically includes a management portal and/or an executable for backup and restore operations, and/or a data repository e.g. a Microsoft SQL database aka SQL for storing policies and related data. The system in the present example interacts with Microsoft Graph service to manage policies and incorporates security measures to protect data integrity and access. External Systems may include all or any subset of:
Entra ID: Microsoft Entra ID (Enterprise Identity), primary system which holds the conditional access policies, and is also configured to authenticate and authorize users to the portal.
Graph aka Microsoft Graph: the API used to backup, restore, and collect other information from Entra ID.
Office 365 Exchange Online Service: Used to send email notifications.

Portal Permissions may include all or any subset of:
Manage Admins: Allows the admin (e.g. global admin) to manage other admin permissions.
Advance Operations: Allows the admin e.g. global admin to perform advance operations on selected Entra ID tenants, such as disable all CA policies or return all CA policies of selected Entra ID tenants to a certain point in time.
Allow Restore: Allows admin to perform a restore of a CA policy to a certain point in time on selected Entra ID tenants.
Manage Protection: Allows admin to set CA policy protection to None/Protected/Managed on selected Entra ID tenants.

The system is configured to provide all or any subset of the following functionalities:
Security: Ensure that conditional access policies are protected from unauthorized changes.
Managed State: Implement a workflow for managing policy changes, requiring approvals before changes are applied.
Visualization: Provide a graphical representation of policy changes through the management portal.
Backup and Restore: Enable the backup of policies and the ability to restore individual policies or all policies to a specific point in time. The system typically provides clear and informative feedback to users on the status of operations (e.g. backup, restore, approval).

System Components may include all or any subset of the following:
Management Portal: A web-based interface for administrators, approvers, and auditors to manage and visualize policy changes.
Executable: A command-line responsible for performing backup and restore operations.
Database: A Microsoft SQL Server database for storing backup data, audit logs, display names of objects configured in CA policy and workflow information.

All or any subset of the following features may be provided:
Policy Backup: Regularly scheduled every 5 minutes backups of Entra ID conditional access policies.
Policy Restore: Restore individual policies or all policies to a specified point in time.
Policies Audit Logs: Collect CA policies related audit log.
Change Management: Track changes to policies, including what was changed and when.
Protect: Revert any change identified on Protected CA policy.
Approval Workflow: Changes to Managed policies require approval from designated approvers before being applied.

Graphical Visualization: Visual representation of policy changes and approval workflows in the management portal.

Use Cases may include all or any subset of the following:
UC1: Backup CA Policies
   Actors: Scheduled task that runs every 5 minutes.
   Description: Backs up CA policies using Microsoft Graph.
   Preconditions: An Entra ID tenant configured in the database with Entra ID application with popper permissions.
   Postconditions: CA policies are backed up and stored in the database.
UC2: Restore CA Policies
   Actors: Administrator and scheduled task
   Description: The administrator restores CA policies to a specific point in time using the web portal, then the scheduled task picks the restore job and performs the restore process using Microsoft Graph.
   Preconditions: The administrator is authenticated to the portal and has the necessary permissions.
   Postconditions: Policies are restored to the specified state.
UC3: Protected CA Policies
   Actors: Scheduled task
   Description: The scheduled task identifies a change in protected policy, then it restores it to its protected state using Microsoft Graph.
   Preconditions: An administrator configured the CA policy to protected state using the web portal.
   Postconditions: Policies are restored to their protected state using Microsoft Graph.
UC4: Approve Policy Changes
   Actors: Administrator and scheduled task
   Description: The scheduled task identifies a change in a managed policy, then the scheduled task writes the change into the SQL database in case there is no change pending for this policy, notifies the approvers e.g. via email, and restores the policy to its previous state using Microsoft Graph; if the change is approved through the web portal, it restores the changed state using Microsoft Graph; the change can also be denied in the web portal.
   Preconditions: An administrator configured the CA policy to managed state using the web portal.
   Postconditions: Policies are restored to their managed state or the change is approved and applied.
UC5: View Policy Changes
   Actors: Administrator
   Description: The administrator views the history of CA policy changes.
   Preconditions: the administrator is authenticated and has necessary permissions.
   Postconditions: the administrator can view a detailed timeline with the policy changes in the web portal.

Functionalities may include all or any subset of the following:

### 1. Backup of Policies e.g. of Entra ID CA Policies

The system may back up the CA policies using an executable that may run repeatedly as a scheduled task e.g. periodically—say every 5 minutes. Every time a CA policy change occurs, the policy change's configuration is retrieved including display names of objects configured in the CA policy, typically using Microsoft Graph, thereby to generate “backup data”. The system may store backup data in, say, a Microsoft SQL database.

### 2. Restore of Policies e.g. of Entra ID CA Policies

The system may allow administrators to restore individual policies to a specified point in time. The system may allow administrators to restore all policies to a specified point in time.

### 3. Disable of Policies e.g. of All Entra ID CA Policies

The system may allow administrators to disable all CA policies.

### 4. Approval Workflow

The system may require that any changes to CA policies configured as managed be approved by designated approvers before being applied. The system may send notifications to approvers when changes are identified.
The system may restore managed state until approved and save change configuration into the database unless there is a change pending. The system may allow approvers to approve or reject changes through the management web portal.
The system may allow protection level (of a given policy) to be set through the management web portal.

### 5. CA Policy Protection

The system may restore a CA policy to its protected state when one is changed. The system may notify administrators of the change and restoration of the protected CA policy.

### 6. Audit Log

The system may collect CA policies related audit log using Microsoft Graph. The system may store the collected logs in Microsoft SQL database.

### 7. Visualization

The system may provide graphical representation of applications and location of sign-ins where CA policies were not applied. The system may allow administrators to view the state of all the policies and number of backups. The system may provide a graphical representation of policy changes over time. The system may allow administrators to change the protection level of a policy. The system may allow administrators to view changes of managed CA policies and approvals. The system may allow administrators to select a point in time view all the CA policies' status at the selected point in time and restore them to that point in time. The system may provide an indication e.g. graphical representation of restore jobs and their status. The system may provide an indication e.g. graphical representation of the portal logs and CA policies audit logs.

Security may be provided by all or any subset of the following measures, by way of example:
The system may use encryption to protect data in transit.
The system may implement OAuth2 authentication in the web portal.
The system may implement audit log to any action taken in the web portal.
According to certain embodiments, all of any subset of the following main components interact with each other and with external systems:
Management Portal: A web-based interface for administrators, and approvers to manage and visualize policy changes and audit logs.
Executable for backup and restore operations: A command-line application responsible for performing backup, restore operations and collection of display names and audit logs from Entra ID using Microsoft Graph.
Database: e.g. Microsoft SQL Server database for storing backup data, audit logs, and workflow information.

The Management Portal may include UI Components such as but not limited to Dashboards, policy visualization, approval workflow interface, Client-Side Logic e.g. handling user interactions, form validations and API calls, an API Layer e.g. RESTful APIs for front-end communication and interaction with the SQL database and Authentication and Authorization: e.g. integration with Entra ID for user authentication.

The Executable may have a Backup Module which handles extraction of Entra ID CA policies using Microsoft Graph and stores them in the database. A Restore Module may retrieve CA policies from the database and restore them to Entra ID. Logging and Error Handling functionality may include comprehensive logging for auditing and error handling to ensure reliable operations.

Regarding the database, any suitable schema design may be employed, typically including tables for storing all or any subset of policies, admins, policy objects/display names, audit logs, restore jobs etc. For example, all or any subset of the following tables may be provided e.g. in a relational database:
Tbl_admins: contains administrators information and permissions.
Tbl_tenants: contains Entra ID tenant information
Tbl_adminId2tenantId: linking table between tbl_admins and tbl_tenants.
Tbl_audit: portal operations audit table.
Tbl_configuration: basic portal configuration.
Tbl_logs: contains executable operations log.
Tbl_runs: contains executable run information.
Tbl_signinsAuditLogs: contains Entra ID sign-ins audit logs.
Tbl_signInsAuditLogsExcludedApplications: contains excluded applications for the web portal dashboard.
Tbl_directoryAuditLogs: contains Entra ID directory audit log.
Tbl_restoreJobs: contains information of restore jobs.

Display names tables: contain GUID to display name
Tbl_applications
Tbl_authenticationContext
Tbl_directoryRoles
Tbl_externalTenants
Tbl_groups
Tbl_namedLocations
Tbl_users

Any suitable component interactions may be provided, such as but not limited to the following processes. Each of the processes below may include all or any subset of the below operations, suitably ordered e.g. as shown:
a. Backup Process: Executable runs every 5 minutes using task scheduler. It identifies changes in Entra ID CA policy through Graph, and if the policy is protected, it restores it to its protected state through Graph and sends an email notification, else Database logs changed Entra ID CA policy configuration and sends email notification.

### 2. Restore Process

a. Administrator initiates a restore via the Web Portal.
b. Portal Backend receives the restore request and logs them into the Database.
c. Executable retrieves the specified policies from the Database and restores them to Entra ID through Microsoft Graph.
d. Database logs the restore operation.

### 3. Approval Workflow

a. Executable identifies change to managed policy, in case there is no change already pending, the Database logs the change request, sends email notification to approver then restores the Entra ID to its managed state.
b. Approver approves the request in the Web Portal which is logged into the Database.
c. Executable restores the approved change into Entra ID
d. Database logs the restored change into the managed policy.
Any suitable Technology Stack may be employed e.g.:
Frontend, Backend: NextJS.
Database: Microsoft SQL Server.
Executable: dotNet.
API: RESTful APIs.

Any suitable Management Portal Design may be employed. Typically, the Management Portal is a web-based interface designed for administrators and approvers who manage Entra ID conditional access policies. The portal typically provides functionalities for visualizing policy changes, managing backups and restores, and handling approval workflows. The portal ensures secure access through role-based permissions and integrates seamlessly with the backend and database components.

The system's user interface may include all or any subset of the following:

### 1. Dashboard

Tenant selection
Time frame selection
Overview of changes in policies, successful not applied sign-ins and not applied sign-in applications

### 2. CA Policies

Tenant selection
List view or policies with their protection level, last modification date-time and state.

### 3. Advanced Operations

Tenant selection
Datetime selection
List view of policies based on the selection

### 4. Managed Policies Change Requests

Tenant selection
List view of change requests

### 5. Restore Jobs Status

Tenant selection
List view of restore jobs with their status

### 6. CA Gatekeeper Logs

List view of executable logs

### 7. CA NotApplied Sign-Ins Audit Log

List view of CA notApplied signIns Entra ID audit log

### 8. CA Audit Log

List view of audit log

### 9. CA Gatekeeper Audit Log

List view of portal audit log
   10. Settings—Tabs—which may include all or any subset of the following:
Admins
Interface to manage administrators
Tenants
Interface to manage tenants
Update/Basic Configuration
Interface to update the solution
   11. Policy Changes—user interface components may include all or any subset of:
Timeline: a horizontal slider with timestamps (e.g. Dec. 5, 2024, 15:19:28) shows the points in time when changes were made.
Current Configuration Indicator: indicates the current configuration on the timeline.
Change's view: graphical representation of the changes in the policy from the Current Configuration to the selected timestamp as a tree of changes indicating each removed configuration as (say) a red minus sign and each added configuration as (say) a green plus sign.

Typically, a current configuration is a configuration of a given conditional access policy (or other object/digital entity) resulting from changes made at the most recent time-point along a time-line of changes to this object/digital entity, as well as all changes made at all previous time-points.

The Executable is a command-line responsible for performing the backup and restore operations of Entra ID conditional access policies. The Executable typically interfaces with Microsoft Graph to extract and restore policies, and typically interacts with the Microsoft SQL Database to store and retrieve backup data. Any suitable scheduling of the executable may be employed e.g. the executable may run using Windows Task Scheduler repeatedly e.g. every 5 minutes.

The Executable typically ensures data integrity and provides robust logging and error-handling mechanisms. Thus, the Executable's functionality may include all or any subset of the following functionalities:

### Change Requests Handling

Retrieve and Apply Approved Change Requests:
Fetch change requests from tbl_managedPolicyChanges where approved=1 and applied!=1.
Restore these policies using Microsoft Graph, prefixing the CA policy display name with “*** Managed by CAGK ** *”.
Mark the change request as applied in the database.
Update lastProtectRestoreDatetime in tbl_policies for the respective policy.

### Restore Jobs Handling

For example, responsive to a user selecting a timepoint along a time-line that the system has generated and presented for a given policy P, and requesting that policy P be restored to that selected timepoint.

Retrieve and Complete Restore Jobs:
Fetch restore jobs from tbl_restoreJobs where finished!=1.
Restore these jobs using Microsoft Graph.
Mark the restore jobs as finished in the database.

### Policy Management for Each Entra ID Tenant

Handle Protected/Managed Policies:
Fetch policies from tbl_policies where (protected=1 OR managed=1) AND renamed!=1.
Prefix these policies accordingly with “*** Protected by CAGK” or “Managed by CAGK ***” where CAGK (used to refer to any embodiment of the system described herein) may be replaced by GK herein.

Update lastProtected RestoreDateTime with the datetime of the change and displayNameB4Protect with the CA display name.

Handle Unprotected Renamed Policies:

Fetch policies from tbl_policies where protected=0 and managed=0 and renamed=1. Rename these policies to the value in displayNameB4Protect and set renamed to 0.

### Logging and Notifications

Audit Logs:

Retrieve sign-in audit log changes since the last check and save them into tbl_signInsAuditLog; and/or

Retrieve directory audit log changes since the last check and save them into tbl_directoryAuditLog.

And/or

CA Policy Synchronization and Notification e.g. by performing all or any subset of the following operations, suitably ordered, e.g., as follows:
Fetch CA policies using Microsoft Graph.
Retrieve existing CA policies from the database for this tenant into a list.
For each CA policy:
   If the policy does not exist in the database perform all or any subset of
      Add the policy to the database.
      Collect and store the policy's configured objects' display names.
      Send email (or,other suitable notification) to administrators notifying about the new policy.
   If the policy exists:
      if the policy's modified date differs from the database:
         If the policy is not protected or managed, perform all or any subset of
         Update the policy in the database.
         Collect and store the policy's configured objects' display names.
         Send an email notification to administrators about the change.
         If the policy is protected:
         Restore the policy to its protected state from the database e.g. using Microsoft Graph.
         Notify administrators.
         If the policy is managed:
         if there is no pending change perform all or any subset of:
         Add the configuration to tbl_managedPolicyChanges.
         Notify approvers.
         Restore the policy to its managed state.
      Remove the policy from the list of database policies
   Mark policies left in the existing policies list (from the database e.g.) as deleted in tbl_policies.
Example technology stack:
Language: dotNet.
API Interaction: REST API calls to interact with Microsoft Graph for policy extraction and restoration.
Database Interaction: SQL queries (e.g. the EXE queries the database or Entra ID) to store and retrieve backup data.

The database design is typically configured for storing backup data for Entra ID conditional access policies and/or for tracking changes, and/or for managing approval workflows, and/or for ensuring data integrity and security. The database may be implemented using Microsoft SQL Server and may comprise plural tables and relationships to support system functionalities.

Example Data Model-Entity-Relationship Diagram (ERD) may include all or any subset of the following:

### 1. tbl_adminId2tenantId

Columns may include all or any subset of:
id (Primary Key): Unique identifier for the admin-tenant relationship.
adminId: Reference to the administrator.
tenantId: Reference to the tenant.

Relationships:
Foreign key adminId references tbl_admins.id.
Foreign key tenantId references tbl_tenants.id.

### 2. tbl_admins

Columns may include all or any subset of:
id (Primary Key): Unique identifier for each administrator.
displayName: Display name of the administrator.
firstName: First name of the administrator.
lastName: Last name of the administrator.
upn: User principal name.
email: Email address of the administrator.
allowRestore: Permission to allow restore operations.
manageAdmins: Permission to manage other administrators.
allowAdvancedOperations: Permission to perform advanced operations.
manageProtection: Permission to manage protection settings.

### 3. tbl_Applications

Columns may include all or any subset of:
id (Primary Key): Unique identifier for the application.
appId: Application ID.
displayName: Display name of the application.

### 4. tbl_Audit

Columns may include all or any subset of:
id (Primary Key): Unique identifier for each audit entry.
auditDateTime: Timestamp of the audit entry.
userId: Reference to the user who performed the action.
description: Description of the audit entry.

Indexes:
NonClusteredIndex-auditDateTime on auditDateTime.

### 5. tbl_AuthenticationContext

Columns may include all or any subset of:
id (Primary Key): Unique identifier for the authentication context.
displayName: Display name of the authentication context.

### 6. tbl_Configuration

Columns may include all or any subset of:
id (Primary Key): Unique identifier for the configuration entry.
version: Version of the configuration.
updating: Flag indicating if the configuration is being updated.
portalUrl: URL of the management portal.

### 7. tbl_directoryAuditLogs

Columns may include all or any subset of:
id (Primary Key): Unique identifier for each directory audit log entry.
tenantId: Reference to the tenant.
auditId: Audit identifier.
result: Result of the audit operation.
resultReason: Reason for the audit result.
activitiDisplayName: Display name of the activity.
activityDateTime: Timestamp of the activity.
operationType: Type of operation.
initiatedByUserId: User ID of the initiator.
initiated ByUserDisplayName: Display name of the initiator.
initiatedByUserPrincipalName: User principal name of the initiator.
initiatedByUserIpAddress: IP address of the initiator.
initiated ByUserType: Type of the initiator (e.g., user, app).
initiated ByUserHomeTenantId: Home tenant ID of the initiator.
initiated ByUserHomeTenantName: Home tenant name of the initiator.
initiated ByAppId: App ID of the initiator.
initiatedByAppDisplayName: Display name of the app.
initiated ByAppServicePrincipalId: Service principal ID of the initiator.
initiated ByAppServicePrincipalName: Service principal name of the initiator.
targetResourceId: Resource ID of the target.
targetResourceDisplayName: Display name of the target resource.
targetResourceType: Type of the target resource.
targetResourceUserPrincipalName: User principal name of the target resource.
targetResourceGroupType: Group type of the target resource.
target ResourceModifiedPropertiesDisplayName: Display name of the modified properties.
targetResourceModifiedPropertiesOldValue: Old value of the modified properties.
targetResourceModifiedPropertiesNewValue: New value of the modified properties.

Indexes:
auditId on auditId.
NonClusteredIndex-activiryDate Time on activityDate Time.

### 8. tbl_directoryRoles

Columns may include all or any subset of:
id (Primary Key): Unique identifier for the directory role.
displayName: Display name of the directory role.

### 9. tbl_externalTenants

Columns may include all or any subset of:
id (Primary Key): Unique identifier for the external tenant.
defaultDomainName: Default domain name of the external tenant.
displayName: Display name of the external tenant. 10. tbl_groups

Columns may include all or any subset of:
id (Primary Key): Unique identifier for the group.
displayName: Display name of the group.

### 11. tbl_logs

Columns may include all or any subset of:
id (Primary Key): Unique identifier for each log entry.
logDateTime: Timestamp of the log entry.
tenantId: Reference to the tenant.
source: Source of the log entry.
status: Status of the operation.
description: Description of the log entry.

Indexes: NonClusteredIndex-logDateTime on logDateTime.

### 12. tbl_managedPolicyChanges

Columns may include all or any subset of:
id (Primary Key): Unique identifier for each managed policy change.
tenantId: Reference to the tenant.
policyId: Reference to the policy.
modifiedDateTime: Timestamp of the modification.
displayName: Display name of the policy.
previousPolicy: Serialized data of the previous policy state.
changedPolicy: Serialized data of the changed policy state.
approved: Approval status of the change.
approveDateTime: Timestamp of the approval.
approvedByAdminId: Reference to the administrator who approved the change.
applied: Status indicating if the change has been applied.

### 13. tbl_namedLocations

Columns may include all or any subset of:
id (Primary Key): Unique identifier for the named location.
displayName: Display name of the named location.

### 14. tbl_policies

Columns may include all or any subset of:
id (Primary Key): Unique identifier for each policy.
tenantId: Reference to the tenant.
policyId: Unique identifier for the policy.
templateId: Reference to the policy template.
displayName: Display name of the policy.
created DateTime: Timestamp of policy creation.
modifiedDateTime: Timestamp of the last modification.
state: State of the policy (e.g., active, inactive).
policy: Serialized data of the policy.
deleted: Flag indicating if the policy is deleted.
protect: Flag indicating if the policy is protected.
managed: Flag indicating if the policy is managed.
renamed: Flag indicating if the policy is renamed.
lastProtectRestoreDateTime: Timestamp of the last protection or restore operation.
displayNameB4Protect: Display name before protection.

### Indexes

NonClusteredIndex-modifiedDateTime on modifiedDateTime.

### Constraints

DF_tbl_polic_delet_33D4B598 default constraint on deleted.

### 15. tbl_restoreJobs

Columns may include all or any subset of:
id (Primary Key): Unique identifier for each restore job.
submitDateTime: Timestamp when the restore job was submitted.
submittedBy: Reference to the administrator who submitted the restore job.
policyRowId: Reference to the policy to be restored.
started: Status indicating if the restore job has started.
finished: Status indicating if the restore job has finished.
startedOn: Timestamp when the restore job started.
restoreStatus: Status message of the restore job.

### 16. tbl_runs

Columns may include all or any subset of:
id (Primary Key): Unique identifier for each run.
lastChangesRun: Timestamp of the last changes run.
lastSigninAuditRun: Timestamp of the last sign-in audit run.

### 17. tbl_signInsAuditLogs

Columns may include all or any subset of:
id (Primary Key): Unique identifier for each sign-in audit log entry.
tenantId: Reference to the tenant.
   signInsAuditLogId: Unique identifier for the sign-in audit log.
   created DateTime: Timestamp of the sign-in.
   user DisplayName: Display name of the user.
   userPrincipalName: User principal name.

It is appreciated that for each of the above, all or any subset of the columns and indexes and constraints listed above, may be provided.

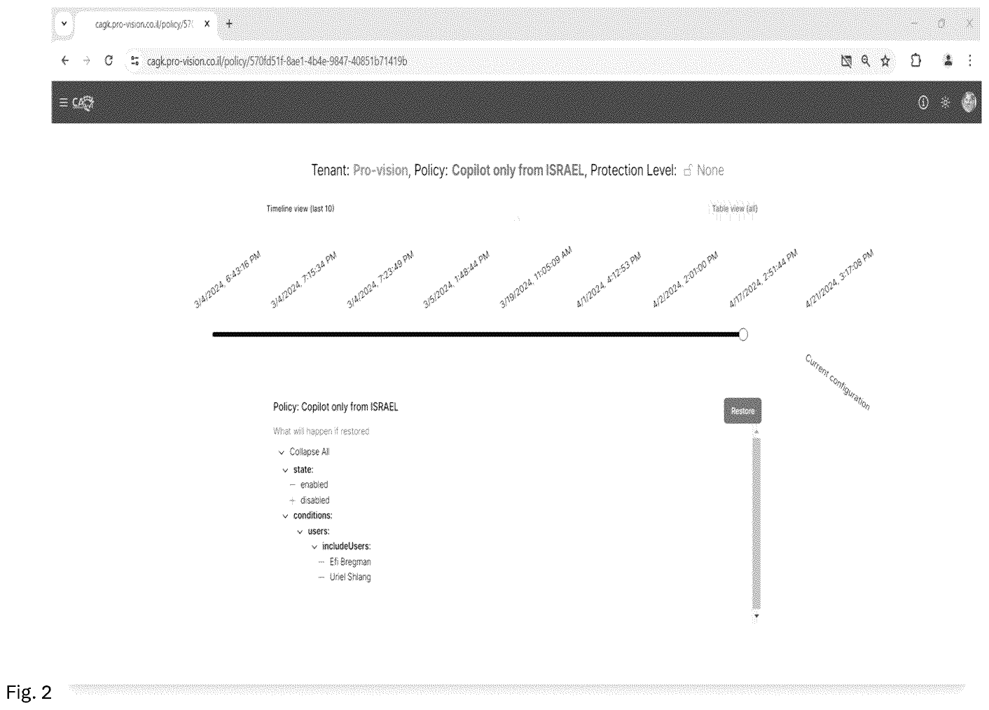

Reference is now made to FIG. 2 which is an example simplified screen display which may be generated by a system of the present invention. The screen display shows an example timeline for an example policy whose display name is “Copilot only from ISRAEL”. The timeline shows various time-points, such as 17 Apr. 2024 at 2:51:44 o′clock, at which the “Copilot only from ISRAEL” policy was changed. The configuration or state of the “Copilot only from ISRAEL” policy at a given time-point is typically displayed, e.g. hierarchically, if a given time-point is selected e.g. using a cursor.

In generating a time-line for a policy x, such as “Copilot only from ISRAEL”, any suitable method may be employed to identify all time-points at which policy x changed, so as to include all of those time-points and only those time-points in policy x's timeline. For example, each policy may have a modifiedDateTime parameter (e.g. Apr. 2, 2024, 4:13:11 PM) which may then be compared to the last modifiedDateTime of that policy in the database in tbl_policies.

Any suitable method may be employed to generate the intuitive/graphical display of a policy's configuration at a given time-point, e.g. as shown in FIG. 2, from the Entra ID log, which, as shown, is typically hierarchical (tree structure e.g.). For example, GUIDs may be converted into display names using a GUID table as described herein. Typically, each policy is a JSON object, and that JSON typically comprises GUID's of objects in Entra ID. Those GUIDs and their displayNames may be collected every time a new CA policy or a policy change occurs. In the portal, when interpreting the GUI, those GUID's are replaced with the displayNames that exist in the database in tables such as, for example, all or any subset of: Tbl_application, Tbl_authenticationContext, Tbl_directoryRoles, Tbl_groups, Tbl_namedLocations, Tbl_users, Tbl_externalTenants. This also allows the portal to search policies by displayNames and show only policies that contain GUID's of those displayNames, whether they are users, groups, etc.

According to certain embodiments, each CA policy is a JSON object, listing all policy properties. Some properties of this JSON may be stored as GUID/s of Entra ID objects rather than user-friendly displayName. For example: the “Microsoft Office” application may be stored as “d3590ed6-52b3-4102-aeff-aad2292ab01c” in the CA policy JSON object. Each time the system performs a backup of Entra ID CA Policies e.g. as described elsewhere herein, CA policy/ies may have changed and/or new CA policy/ies may have been created since the last time the backup ran, in which case the system may perform all or any subset of the following operations, suitably ordered e.g. as follows:
Read the CA policies JSON object(s).
For each GUID found in the JSON object, the system may read the displayName property of the associated Entra ID object (using Microsoft Graph).
The system may save, e.g. to the SQL database, the GUID along with its displayName property.

Typically, the system stores the GUIDs along with the associated displayNames property in all or any subset of the following tables (e.g. in an SQL database as described herein):
Tbl_application-includes a list of all Entra ID applications listed in CA policies.
Tbl_authenticationContext-includes a list of all Entra ID Authentication Context listed in CA policies.
Tbl_directoryRoles-includes a list of all Entra ID Directory Roles listed in CA policies.
Tbl_groups-includes a list of all Entra ID Groups listed in CA policies.
Tbl_namedLocations-includes a list of all Entra ID Named Locations listed in CA policies.
Tbl_users-includes a list of all EntraID Users listed in CA policies.
Tbl_externalTenants-includes a list of all Entra ID External Tenants listed in CA policies

When a system admin types a text in the Search box, the system may search for that text in all the above tables, and may show (filter out) only CA policies that contain the specific text. This enables a given system admin to search all CA policies using friendly names (i.e., displayNames property value) instead of executing the search based on the actual value stored in the CA policies in Entra ID (i.e., GUID). However, the above embodiment is not intended to be limiting e.g. in order to identify which CA policies have been defined which protect (apply to) a given asset of a given tenant or organization e.g. SharePoint (or some application A). Alternatively, any suitable in-policy search features may be provided.

It is appreciated that the above implementation also typically allows the system's portal to search policies by a displayName of, say, a user, group, application, and show only policies that contain GUID's of those displayNames. It is appreciated that any suitable technique may be employed to derive a display name from Entra ID. Typically, when a user is searching for an application that is listed in Entra ID using that name, the application's display name is converted in the background to the GUID of the application when running the search against the database of policies.

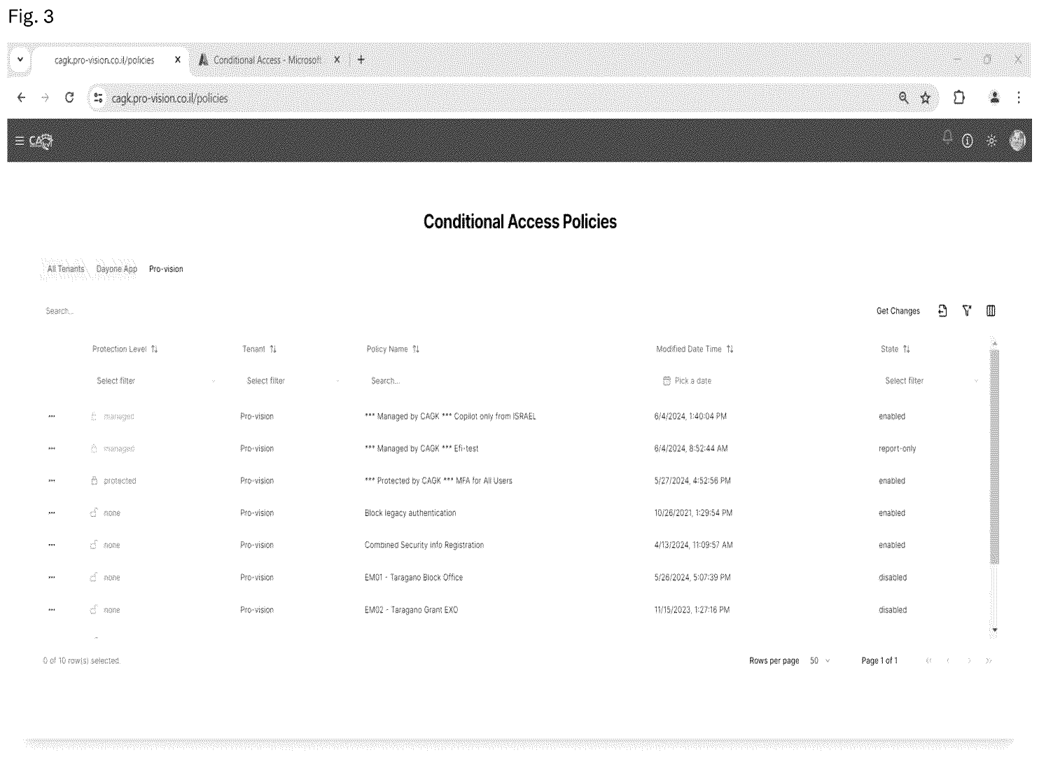

FIG. 3 is an example simplified screen display which may be generated by a system of the present invention. The screen display or similar may be used to present to a user all policies which protect or affect a given asset or application, e.g. “SharePoint”. The user may elect to filter policies' protection levels (second column) e.g. to view only managed policies, or only protected policies. Similarly, the user may elect to filter policies' states (disabled/enabled) e.g. to view only enabled policies, or only disabled policies, or to filter out certain tenants (column 3).

Regarding managed policies, it is appreciated that when a change to a managed policy (a change to a policy which can be changed but only pending admin approval, as opposed to policies which do not require admin approval to change, and as opposed to policies which cannot be changed) is detected, that change may be saved e.g. into tbl_managedPolicyChanges table, the admins configured with manageProtection permission for that tenant are notified and the previous state is restored to Entra ID. When the change is approved by the admins, the approved state is restored and the restored policy may be added to tbl_policies. According to certain embodiments, each time a user U changes a “managed” policy, this change is temporarily overridden by temporarily (e.g. until receipt of approval) reverting the policy configuration back to its state before the change initiated by user U. This is possible assuming any admin is entitled to make changes to CA policy in Entra ID, including the application which automatically performs the temporary override, since in that application's configuration there is typically a servicePrincipal and/or secret with permissions to modify CA policies. Typically, this configuration is an integral part of configuring an Entra ID tenant in the portal.

### Single Platform Embodiment

According to certain embodiments, a single platform or body of code implements all or any subset of functionalities described herein (e.g. all or any subset of the system's functionalities, such as policy change protection functionality) and also implements the policy changes that the system (aka GK) protects.

According to this embodiment, the single body of code may provide a New Restore

Feature which allows a user to view and revert to previous versions of conditional access policies. This can help the user recover from accidental or unwanted changes, or compare different versions of the policies.

To access the restore feature, the user may perform all or any subset of the following operations, suitably ordered e.g. as follows:
Go to the conditional access policies page in the Azure portal.
Select the policy that the user wants to restore.
Click on the context menu (the three dots) on the right side of the policy name.
Select the restore option from the menu.

How to use the restore feature: When the user selects the restore option, the user may see either a timeline of changes or a table of changes, depending on the number and frequency of changes made to the policy. If the user sees a timeline of changes, the user may use the slider or the arrows to navigate through the different versions of the policy. The user typically is also shown the date and time of each change, and the user who made the change. If the user sees a table of changes, the user may use filters or a search box to find a version of the policy that user seeks to restore. The user may also be shown the date and time of each change, and the user who made the change.

To restore a previous version of the policy, the user may select the version that the user wants to restore and click on the restore button. The user may then be shown a confirmation message asking the user to review the changes and confirm the restore action. The user may then click on the confirm button to complete the restore process.

To view changes from the current state of the policy, the user may select the version that the user wants to compare, followed by a click on the compare button. The user may, responsively, be shown a side-by-side comparison of the current and the selected version of the policy, highlighting differences in each setting. The user may also switch between the current and selected versions e.g. by clicking on a toggle button.

One possible implementation for a conditional access engine is as follows: the engine includes a set of rules that define conditions and actions for each policy. Each rule typically includes a name and/or priority, and/or scope, and/or trigger, and/or response. Specifically, the scope typically defines the target resources and users that a given policy applies to, such as applications, devices, groups, or roles. The trigger typically defines the event or state that activates the policy, such as sign-in, device enrollment, or risk detection. The response typically defines the action or outcome that the policy enforces, such as grant, block, challenge, or remediate. The priority typically defines the order of evaluation of the rules, in case of conflicts or overlaps. The rule with the highest priority takes precedence over the others.

Typically, the engine evaluates the rules based on the priority, scope, and trigger, and executes the response accordingly. The engine also logs the policy evaluation and execution results for auditing and reporting purposes.

To add features to the conditional access engine, e.g. locking policies and/or managing changes with a workflow process, the system may, for example, be extended as follows:
a. To lock a policy, add a new attribute to the rule that indicates whether the policy is locked or not. A locked policy cannot be modified or deleted by anyone, except by the owner or an administrator. The engine can check the lock attribute before applying any changes to the policy, and reject any unauthorized attempts; and/or
b. To manage changes with a workflow process, a new attribute may be added to the rule that indicates the status of the policy, such as pending, approved, or rejected. A pending policy is a policy that has been created or modified, but not yet approved by a supervisor or an administrator. The engine can check the status attribute before executing the policy, and only execute policies that have been approved. The engine may notify relevant stakeholders about pending policies, including the approval status of each.

Embodiments herein provide significant advantages over (or to) state-of-the-art cloud security systems because conditional access policies are critical for securing access to enterprise resources. However, managing these policies can be challenging, given prevalent needs for frequent updates and the existence of risk of unauthorized changes.

Embodiments herein reduce damage to an organization which can occur upon loss of or damage to tenant conditional access policies due to accidental deletion, malicious attacks, or human errors, by reducing probabilities of these occurrences. For example, the system herein may make such loss or damage easier to cope with, since the system facilitates capability restoration in an event of accidental policy deletion and/or malicious attacks. The system herein may also make such damage and/or loss less likely by providing policy protection and/or policy management (requiring approval before any policy change is implemented).

Embodiments herein also provide reliable conditional access policy backup and restore functionality due to the system's ability to enable a user to, with just a few clicks, recover policies which existed on a specific date and at a given time.

Certain embodiments enable policies that were in effect on different dates, to be efficiently compared.

Certain embodiments enable organizations to efficiently comply with regulatory and audit requirements for policy management. For example, the system herein typically automatically provides an audit log repository unlimited in time or in excess of 180 days, facilitating handling of audit requirements.

Alternatively, or in addition, the system herein may provide “Lock mode” functionality/capability, where no changes in conditional access policies are allowed, including creating new policies (e.g. the system may remove new policies once the system is in “Lock mode”). This may facilitate regulatory policy management requirements, e.g., regulations which require that no change is to be allowed to occur that is unmanaged; compliance may be achieved by preventing such changes.

According to certain embodiments, the system accesses Entra ID's conditional access data every 5 (say) minutes to pull updates, via a suitable API e.g. Microsoft Graph. The system may then retrieve (typically only) those policies which have changed over the course of these 5 (say) minutes. The system may also pull ENTRA ID logs (aka audit logs, typically in JSON format), e.g., via the same API, both to store these beyond the 180 day period (say) given by Entra ID, and/or to provide data regarding the specific admin/user who made certain changes, in case this data is required. The system may retrieve (typically only) the last 5 (say) minutes of the log. These log snippets (which typically indicate not only what changes were made, but who made them) may be stored, typically time-stamped, in the system database, thereby to define a table of time-stamped log portions stored in the system database.

All or some of the JSON data pulled from Entra ID which describes policies defined via Entra ID, may be stored as strings in the system database (e.g. a given string may represent a given conditional access policy in JSON format, as pulled at a given time, typically because that policy has changed since the last time Entra ID was accessed). Each string in the database is typically time-stamped to indicate the time-point at which this was the policy's configuration. Each string may also be associated with a field identifying the policy (e.g. its GUID), thereby to define a table of time-stamped policy configurations stored in the system database. The system (e.g. the system portal) then compares a current configuration of a policy of interest, and a configuration of the same policy at another, user-selected point in time; typically this occurs when the admin selects the point in time, e.g., in real time or near-real time. This comparison may be performed efficiently by simply comparing the two strings which respectively represent the two configurations of the policy of interest, and providing an indication (typically as structured text e.g. XML, taking into account the known components of a policy configuration such as state, conditions, etc.) of all differences between the two strings, to the requesting admin/user.

Certain embodiments provide security, e.g., encryption and/or authentication, which protects and ensures the safety and integrity of an organization's conditional access policies.

Certain embodiments provide reports and logs to monitor and track policy modification activities.

Embodiments herein can facilitate a heuristic for extremely rapid stop-gap resolution of a conditional access policy crisis, by reverting all current conditional access policy settings to settings in effect at a previous time-point on a previous date, at/on which an administrator knows that the conditional access policy crisis had not yet broken out. This may be accomplished using any embodiment herein. For example, a user interface may be configured for enabling an administrator to enter a date selection input which selects a time-point T e.g. date D, at/on which conditional access policies being managed by the system had settings S. Conditional access policy over-ride functionality may re-set or restore current conditional access policies to settings S which were in effect at the time-point T on the date D, typically responsive to the date selection input and responsive to a “restore” input from a user e.g. using a virtual “restore” button.

It is appreciated that the system herein typically stores time-stamped changes made by (typically administrative) users who interface with software (e.g. changes made to any object/digital entity such as but not limited to a conditional access policy) and then, e.g., upon demand, generates cumulative data which represents differences between a current situation (typically a current state of the object/policy including, say, current values of conditional access policy characteristics) relative to a given (typically user-selected) time-point t1 in which the state was typically different and certain values of conditional access policy characteristics (or, more generally, object characteristics) were typically different; for example, perhaps a certain policy was enabled at t1, but is currently disabled. Or, perhaps, for a certain policy, “includeusers” (an example of a policy characteristic; comprises a set of users) included Joe and Mary at t1, but now no longer includes Joe. The data is cumulative because if, for example, the timeline of changes made to the policy includes 5 points e.g. t1-t5 (the most recent change), then a user may request the changes between t1 and the current configuration (as most recently configured at time-point t5 e.g.; the data presented to the user may incorporate the changes made at t2, the changes made at t3, the changes made at t4, and the changes made at t5. The data is also cumulative because a single entry summarizes all changes made to (say) “includeusers”, rather than having a log of all sorts of changes, some to “includeusers” and some to other characteristics, arranged generally chronologically, such that the troubleshooter needs to manually “connect the dots” between changes made to (say) “includeusers” throughout the log (typically after first filtering out these changes alone, from among the changes made to all sorts of other objects (e.g. policy) characteristics. Another single entry summarizes all changes made to (say) the enabled/disabled/report state of a given policy, and so forth. For example, in a “what will happen if restored” report, generated after a user has selected a policy and selected a time-point at which this policy was changed, “-enabled, +disabled” may be used to indicate that the selected policy may, if restored, no longer be enabled, and may, if restored, be disabled. Or, “-Joe, -George” may be used to indicate that if the policy is restored to its configuration at the selected time-point, “includeusers” may no longer include Joe and George. Similarly, changes in roles, and guests defined by a given policy, that may occur if the policy is restored to its configuration at the selected time-point, may be cumulated and presented.

The above functionality (especially when used for time-stamped changes in conditional access policies and possibly for time-stamped software changes to other objects/entities) is particularly useful in conjunction with functionality for identifying all policies which govern access to a given asset, such that if asset (e.g. app) A is not functioning, cumulative data may be queried for all policies relevant to app A.

It is appreciated that the ability to cumulate and present these changes greatly enhances the ability of administrative troubleshooters to detect problems. Many types of software problems affect a large number of users; such problems are typically almost immediately reported by more than one user, such that the culprit can be found by identifying changes just made (e.g. between the just previous time-point along the time-line of changes and the current (most recent) time-point along the time-line of changes to the software (e.g. to the conditional access policy/ies). Other types of software problems affect applications with known, relatively infrequent, times of use, e.g., salary computation, which may be used once a month, or data may otherwise be available indicating which users used the application, and when. This enables the culprit-change to be pinpointed, by comparing the state of the (conditional access policy associated with the) application when it was last successfully used, to the current state or configuration of the (conditional access policy associated with the) application, for which use was unsuccessful (users could not access the app, undesirable users did access the app, and so forth). If an app is now (currently, i.e. under the current configuration of the app's conditional access policy) malfunctioning, e.g., in terms of access thereto, and several time-points of change have elapsed since the app was functioning well (e.g. when used to compute last month's salary), the system herein with its cumulative ability is advantageous in identifying all changes in at least one software object (e.g. conditional access policy) relevant to the malfunctioning app from the time of malfunction until the present time, and typically in identifying all changes in all software objects (e.g. conditional access policies) relevant to the malfunctioning app from the time of malfunction until the present time; it is appreciated that typically, the time of the app's malfunction is the present (e.g. the malfunction is occurring under the current configuration of the app's conditional access policy) whereas the time at which the app was functioning properly is in the past, when an earlier configuration of the app's conditional access policy was in effect.

One possible way to rectify such problems, at least temporarily, is to restore certain conditional access policies to their state at a previous time-point in which the policy is known to have been working well.

The system herein may be implemented as IaaS, or may be implemented as Paas, or may be implemented as SaaS.

It is appreciated that the system's backup ability (e.g. by scanning periodically e.g. every 5 minutes for policy states), as described herein, is exceptionally useful in all or any subset of the following ways:

a. Given a crisis which leaves an organization or tenant with a poorly functioning conditional access state, regarding all or any subset of the tenant's (or organization's) policies, the conditional access settings for the relevant policy/i/es can be restored in a few clicks to their state on an earlier date on which there was no such crisis.

b. If tenant conditional access policies are accidentally deleted, they are backed up, hence can be retrieved and/or re-instated.

c. Allows policies to be protected and/or managed, and/or allows tenant/s to be locked, thereby to guard certain policies (e.g. preventing some/all policies from being changed until global admin approves them or by preventing some/all policies from being changed at all) and/or by preventing formation of new policy/ies for a given “locked” tenant.

It is appreciated that terminology such as “mandatory”, “required”, “need”, and “must” refer to implementation choices made within the context of a particular implementation or application described herewithin for clarity and are not intended to be limiting, since in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices, each including at least one processor and/or cooperating input device and/or output device, and operative to perform, e.g., in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer-or machine-readable media.

Any computations or other forms of analysis described herein may be performed by a suitable computerized method. Any operation or functionality described herein may be wholly or partially computer-implemented, e.g., by one or more processors. The invention shown and described herein may include (a) using a computerized method to identify a solution to any of the problems or for any of the objectives described herein, the solution optionally including at least one of a decision, an action, a product, a service, or any other information described herein, that impacts, in a positive manner, a problem or objectives described herein; and (b) outputting the solution.

The system may, if desired, be implemented as a web-based system employing software, computers, routers, and telecommunications equipment, as appropriate.

Any suitable deployment may be employed to provide functionalities, e.g., software functionalities shown and described herein. For example, a server may store certain applications, for download to clients, which are executed at the client side, the server side serving only as a storehouse. Any or all functionalities, e.g., software functionalities shown and described herein, may be deployed in a cloud environment. Clients, e.g., mobile communication devices such as smartphones, may be operatively associated with, but external to the cloud.

The scope of the present invention is not limited to structures and functions specifically described herein, and is also intended to include devices which have the capacity to yield a structure, or perform a function described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis, e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware, or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous, given the state or condition or data. Alternatively, or in addition, an alert may be provided to an appropriate human operator or to an appropriate external system.

Applicability of the subject matter disclosed herein is not limited to embodiments claimed, nor to solutions for specific disadvantages emphasized herein, nor need any element of any system and method described herein, on its own or in combination with other elements described herein, operate only in environments or use-cases or technology areas such as those described herein.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section or in publications mentioned therein.

Conversely, features of the invention, including operations, which are described for brevity in the context of a single embodiment or in a certain order, may be provided separately or in any suitable sub-combination, including with features known in the art (particularly, although not limited to, those described in the Background section or in publications mentioned therein) or in a different order. “e.g.” is used herein in the sense of a specific example which is not intended to be limiting. Each method may comprise all or any subset of the operations illustrated or described, suitably ordered, e.g., as illustrated or described herein.

Devices, apparatus, or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

1. A conditional access policy management system which enables organizations' administrators to manage conditional access policies controlling user access to respective organizational assets, e.g., apps which respective organizations may store on a cloud, the system comprising:
a user interface enabling an administrator to select a policy, thereby to define a selected policy; and
a processor configured to display a timeline along which a sequence of plural time-points are arranged wherein changes were made in said selected policy at each of said plural time-points.

2. A system according to claim 1 wherein the user interface enables an administrator to select an organizational asset A, and, responsively, said processor is configured to search, among time-points at which changes were made in policies, for first time-points at which changes were made in policies which control user access to organizational asset A, and to provide the administrator with an indication of only said first time-points and not of second time-points at which changes were made only in policies which only control user access to organizational assets other than asset A.

3. A system according to claim 1 wherein the indication of said first time-points which is served to the administrator, includes data, e.g. a tree, indicative of changes made in said policies which control user access to organizational asset A, at each of said first time-points.

4. A system according to claim 1 wherein a change C is deemed to have been made at a time-point T if an administrator keyed in change C then pressed “save” at time-point T.

5. A system according to claim 1 and also comprising a data repository comprising a plurality of records, each corresponding to a policy, wherein each record corresponding to policy P comprises a field indicating organizational assets to which policy P applies.

6. A system according to claim 5 wherein said data indicative of changes comprises, for each time-point T from among said first time-points, a cumulative indication of all changes made at, or by, time-point T to at least one asset.

7. A system according to claim 1 wherein the user interface enables administrators to initiate change of at least one policy.

8. A system according to claim 7 and wherein the user interface enables an administrator super-user to limit changes which can be initiated by an administrator.

9. A system according to claim 8 wherein the user interface limits changes by enabling an administrator super-user to prevent at least one change from being made to at least one policy, by at least one administrator.

10. A system according to claim 1 wherein the user interface limits changes by enabling an administrator super-user to define that at least one change to at least one policy requires approval before going into effect.

11. A system according to claim 1 wherein the conditional access policy management system enables plural organizations' administrators to respectively administer conditional access policies controlling access of each organization's users to each organization's assets, and wherein unique identifiers, e.g., GUIDs, are used to identify entities uniquely over the plural organizations, and wherein each organization assigns display names, typically in clear text or natural language, to said entities, and wherein the system includes a dictionary which stores at least one association between at least one of said unique identifiers and at least one of said display names, and wherein said processor is configured to convert at least one of said unique identifiers to display name/s, for display to an administrator via the user interface, and/or to convert said display names which may have been received from an administrator via the user interface, to unique identifiers, for internal purposes, based on said association.

12. A system according to claim 11 wherein said entities identified by unique identifiers includes at least one user and/or at least one group of users.

13. A system according to claim 12 wherein said entities identified by unique identifiers include an “all users” group to which all an organization's users belong, thereby to display data regarding aspects of conditional access policies which apply to the group of all users in association with an intuitive “all users” display name, enabling even an administrator who has not committed the unique identifier of the “all users” group to memory, to easily identify changes which apply to all users, hence are particularly important.

14. A system according to claim 11 wherein said entities identified by unique identifiers include at least one user and/or at least one app and/or at least one policy and/or at least one tenant and/or at least one organization.

15. A system according to claim 11 wherein at least one organization assigns display names via Microsoft Entra ID.

16. A system according to claim 1 and wherein the processor is configured to serve to the administrator, e.g. upon demand, data indicative of cumulative changes made in said policy at an administrator-selected time-point from among said plural time-points, vis a vis the policy's current configuration.

17. A system according to claim 1 wherein an administrator can query the system to determine which policies control access to a given organizational asset A, and, responsively, the system identifies and presents to the administrator, at least some, e.g., all policies which control access to said organizational asset A.

18. A system according to claim 1 which supports a “Lock Mode” for tenants which, when enabled for a given tenant, prevents changes to any of the given tenant's policies, e.g,. by deleting new policies created for the given tenant while the given tenant is in Lock Mode state.

19. A system according to claim 18 wherein, when a given tenant in Lock Mode is unlocked by a user so authorized, each of the given tenant's policies open back to its respective last state, e.g., Protected/Managed/Neither.

20. A conditional access policy management method comprising:
enabling organizations' administrators to manage conditional access policies controlling user access to respective organizational assets, e.g., apps, which respective organizations may store on a cloud, by:
providing a user interface enabling an administrator to select a policy, thereby to define a selected policy; and
using a processor, generating and displaying a timeline along which a sequence of plural time-points are arranged wherein changes were made in said selected policy at each of said plural time-points.

21. A computer program product, comprising a non-transitory tangible computer readable medium having computer readable program code embodied therein, said computer readable program code adapted to be executed to implement a conditional access policy management method comprising:
enabling organizations' administrators to manage conditional access policies controlling user access to respective organizational assets, e.g., apps, which respective organizations may store on a cloud, by:
providing a user interface enabling an administrator to select a policy, thereby to define a selected policy; and
using a processor, generating and displaying a timeline along which a sequence of plural time-points are arranged wherein changes were made in said selected policy at each of said plural time-points.
